(19) United States
(12) Patent Application Publication
(10) Pub. No.: US 2014/0011113 A1
(43) Pub. Date: Jan. 9, 2014

(54) FUEL CELL

(71) Applicant: NGK INSULATORS, LTD., Nagoya-shi (JP)

(72) Inventors: Makoto OHMORI, Nagoya-sh (JP); Takashi RYU, Nagoya-shi (JP); Taku OKAMOTO, Nagoya-shi (JP)

(73) Assignee: NGK INSULATORS, LTD., Nagoya-shi (JP)

(21) Appl. No.: 13/926,120

(22) Filed: Jun. 25, 2013

(30) Foreign Application Priority Data
Jun. 27, 2012 (JP) 2012-144607
Oct. 11, 2012 (JP) 2012-226235

(51) Int. Cl. H01M 8/02

(52) U.S. Cl. CPC H01M 8/0297
USPC 429/482

(57) ABSTRACT

The fuel cell includes a porous body including Ni particles, ceramic particles and pores; a power-generating section having an anode active layer formed on the porous body; and a dense interconnector formed on the porous body, and electrically connected with the anode active layer. When the porous body is exposed to a reducing atmosphere, the ceramic particles and the pores is greater than or equal to 14 volume % and less than or equal to 55 volume % in the contacting region, a volume ratio of the Ni particles to the total volume is greater than or equal to 15 volume % and less than or equal to 50 volume % in the contacting region, and a volume ratio of the Ni particles to a sum volume of a volume of the ceramic particles and a volume of the Ni particles is less than or equal to 82.5 volume % in the contacting region.

### CROSS-REFERENCE TO RELATED APPLICATIONS

This application claims priority to Japanese Patent Application No. 2012-144607 filed on Jun. 27, 2012 and Japanese Patent Application No. 2012-226235 filed on Oct. 11, 2012. The entire disclosure of Japanese Patent Application No. 2012-144607 and Japanese Patent Application No. 2012-226235 is hereby incorporated herein by reference.

### BACKGROUND

1. Technical Field

The present invention relates to a solid oxide fuel cell.

2. Description of the Related Art

In recent years, fuel cells have attracted attention due to efficient use of energy resources and environmental problems.

A planar type fuel cell including a flow channel in an inner portion generally has a porous anode, a solid electrolyte layer and a cathode sequentially formed on a first principal surface of the anode, and a dense interconnector formed on a second principal surface of the anode (see Japanese Patent Application Laid-Open No. 2007-200761, for example).

For the purpose of enhancing the conductive properties between the anode and the interconnector, a method has been proposed of provision of an intermediate layer between the interconnector and the anode (see Japanese Patent Application Laid-Open No. 2004-253376, for example).

### SUMMARY

However, the fuel cell according to Patent Literature 1 may cause delamination in the interface between the anode and the interconnector during reduction treatment. Furthermore, the fuel cell according to Patent Literature 2 may cause delamination in the interface between the intermediate layer and the interconnector during reduction treatment.

The above effect results from the fact that the expansion amount during reduction of the interconnector as a dense body is greater than the reduction expansion amount of the intermediate layer or the anode as a porous body.

The present invention is proposed in light of the above circumstances, and has the object of providing a fuel cell in which delamination between a porous body and an interconnector can be suppressed.

A fuel cell according to the present invention includes a porous body that includes Ni particles, ceramic particles and pores, and a dense interconnector that is formed on the porous body and is electrically connected to the porous body. The porous body and the interconnector are co-fired. The porous body includes a contacting region within a predetermined distance from a interface with the interconnector. The contacting region is connected to the interconnector. When the porous body is exposed to a reducing atmosphere, a volume ratio of the pores to a total volume of the Ni particles, the ceramic particles and the pores is greater than or equal to 14 volume % and less than or equal to 55 volume % in the contacting region, a volume ratio of the Ni particles to the total volume is greater than or equal to 15 volume % and less than or equal to 50 volume % in the contacting region, and a volume ratio of the Ni particles to a sum volume of a volume of the ceramic particles and a volume of the Ni particles is less than or equal to 82.5 volume % in the contacting region. The respective volume ratios of the Ni particles, the ceramic particles and the pores to the total volume are calculated based on contacting length of each of the Ni particles, the ceramic particles and the pores with the interconnector in the interface between the porous body and the interconnector.

The present invention provides a fuel cell in which delamination between a porous body and an interconnector can be suppressed.

### BRIEF DESCRIPTION OF THE DRAWINGS

Referring now to the attached drawings which form a part of this original disclosure:

FIG. 1 is a cross sectional view illustrating the configuration of a fuel cell.

FIG. 2 is a schematic view of a cross sectional surface of an interface between a support substrate and an interconnector.

FIG. 3 is a three-component composition diagram illustrating a volume ratio of Ni particles, ceramic particles and pores at a contacting region with the support substrate.

FIG. 4 illustrates a calculation method for the volume ratio.

FIG. 5 is a cross sectional view of the configuration of a voltage evaluation apparatus used in conduction testing.

FIG. 6 is a three-component composition diagram illustrating the volume ratio of Ni particles, ceramic particles and pores in Samples No. 1 to No. 22.

FIG. 7 illustrates a Sebastian test.

### DETAILED DESCRIPTION OF THE PREFERRED EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

In the following embodiments, a solid oxide fuel cell (SOFC) will be described as an example of a fuel cell. Although a flat-tubular type fuel cell is described below, the present invention is not limited in this regard, and may be applied to a so-called segmented-in-series fuel cell.

Configuration of Fuel Cell 100

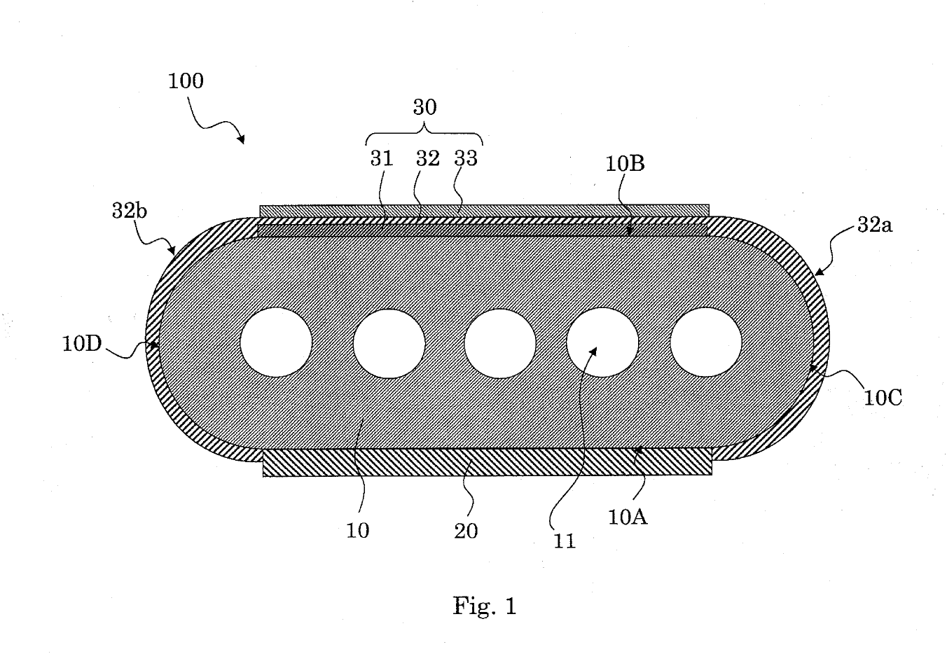

The configuration of a fuel cell (abbreviated below to “cell”) 100 will be described making reference to the figures. FIG. 1 is a cross sectional view of the configuration of the fuel cell 100.

The cell 100 is a flat tabular body configured using a ceramic material. The thickness of the cell 100 is for example 1 mm to 10 mm, with a width of 10 mm to 100 mm, and a length of 50 mm to 500 mm. A cell stack configuring a fuel cell battery may be formed by connecting a plurality of cells 100 in series.

As illustrated in FIG. 1, the cell 100 includes a support substrate 10, an interconnector 20 and a power-generating section 30.

### Support Substrate 10

The support substrate 10 is a tabular body that exhibits a flat cross sectional view. The support substrate 10 for example has a thickness of, for example, 1 mm to 10 mm.

The support substrate 10 exhibits conductive properties configured to transmit a current generated by the power-generating section 30 to the interconnector, and gas permeable properties configured to allow permeation of fuel gas to the power-generating section. An inner portion of the support substrate 10 as illustrated in FIG. 1 includes formation of a plurality of gas flow channels 11 for passage of fuel gas.

The support substrate 10 includes a first flat surface 10A, a second flat surface 10B, a first curved side surface 10C and a second curved side surface 10D. The first flat surface 10A is located on opposite side of the second flat surface 10B, and the first curved side surface 10C is located on opposite side of the second curved side surface 10D. The first flat surface 10A, the second flat surface 10B, the first curved side surface 10C and the second curved side surface 10D are mutually connected to thereby configure the outer peripheral surface of the support substrate 10.

The support substrate 10 includes nickel (Ni) particles, ceramic particles and pores. The support substrate 10 may also contain Ni particles in the form of nickel oxide (NiO) particles. In the present embodiment, the support substrate 10 functions as a current collecting layer. The support substrate 10 is an example of a “porous body”.

The examples of the ceramic particles include yttria-stabilized zirconia (YSZ), calcia-stabilized zirconia (CSZ), rare earth oxides, and perovskite oxides, or the like. However, yttria (Y₂O₃), gadolinium doped ceria (GDC), a chromite-based material such as lanthanum chromite (LaCrO₃), or a titanite-based material such as SrTiO₃ are particularly preferred. The ceramic particles may exhibit conductive properties, or may not exhibit conductive properties.

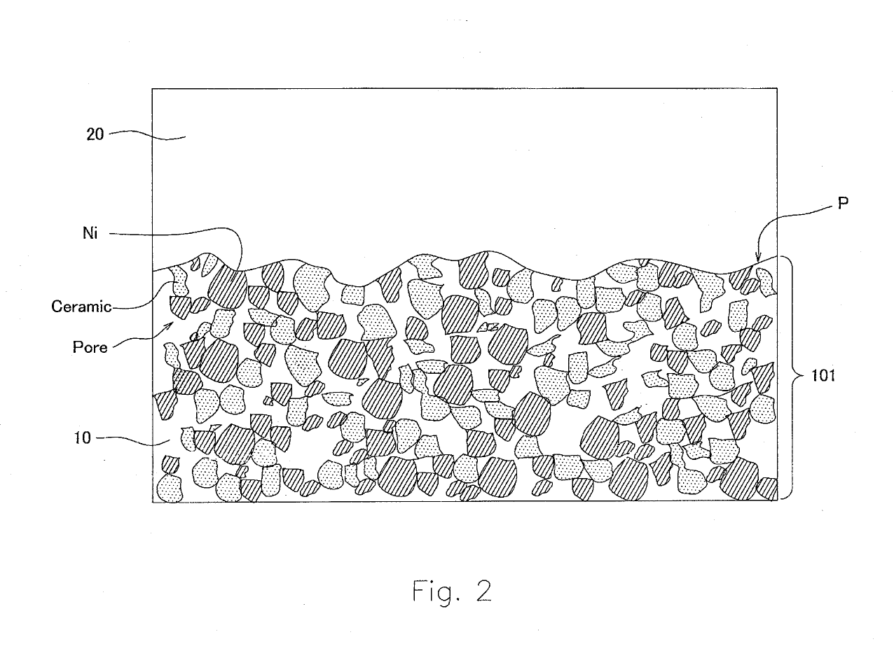

The microstructure of the support substrate 10 will be described below making particular reference to the contacting region 101 (reference is made to FIG. 2) which is contacted with the interconnector 20.

Interconnector 20

The interconnector 20 is disposed on the first flat surface 10A of the support substrate 10. The interconnector 20 is electrically connected to the support substrate 10. The interconnector 20 is cofired with the support substrate 10. The interconnector 20 is denser than the support substrate 10. Therefore, the porosity in the interconnector 20 is lower than the porosity of the support substrate 10. The interconnector 20 collects the current produced in the power generating unit 30 through the support substrate 10. The interconnector 20 has a thickness for example of about 10 microns to 100 microns.

The interconnector 20 is configured with a dense ceramic, for example by a lanthanum-chromite-based perovskite oxide. The lanthanum-chromite-based perovskite oxide includes a material such as La(CrMg)O₃, (LaCa)CrO₃ or (LaSr)CrO₃ in which Mg, Ca, Sr or the like are in a substituted solid solution.

Power-Generating Section 30

The power-generating section 30 is disposed on the second flat surface 10B of the support substrate 10. Therefore, the power-generating section 30 is disposed on the opposite side to the interconnector 20 through the support substrate 10. The power-generating section 30 is configured from an anode active layer 31, a solid electrolyte layer 32, and a cathode 33.

The anode active layer 31 is formed on the second flat surface 10B of the support substrate 10. The anode active layer 31 is configured with ZrO₂ (stabilized zirconia) containing a solid solution of rare earth elements, and Ni and/or NiO. The configuration of ZrO₂ containing a solid solution of rare earth elements preferably includes yttria-stabilized zirconia (3YSZ, 8YSZ, 10YSZ, or the like).

The solid electrolyte layer 32 is disposed between the anode active layer 31 and the cathode 33. The solid electrolyte layer 32 includes a first seal portion 32a and a second seal portion 32b that extend from on the anode active layer 31 to the support substrate 10. The solid electrolyte layer 32 for example has a thickness of approximately 3 microns to 50 microns.

The solid electrolyte layer 32 includes zirconium (Zr). The solid electrolyte layer 32 may include zirconium in the form of zirconia (ZrO₂), and may include zirconia as a main component. The material used in the solid electrolyte layer 12 includes zirconia-based materials such as ScSZ or yttria-stabilized zirconia like 3YSZ, 8YSZ, and 10YSZ or ScSZ.

The cathode 33 is disposed on the solid electrolyte layer 32. The cathode 33 has a thickness for example of 10 microns to 100 microns. The cathode 33 is configured with a conductive ceramic such as a perovskite oxide expressed by the general formula ABO₃. The perovskite oxide includes transition metal perovskite oxides, and in particular, use is preferred of LaCoO₃ oxides, LaFeO₃ oxides, or LaMnO₃ oxides including La at the A site, or the like. A barrier layer may be interposed between the cathode 33 and the electrolyte to prevent reactions between those two components. The material used in the barrier layer preferably includes ceria doped with Gd or Sm.

Microstructure of the Support Substrate 10

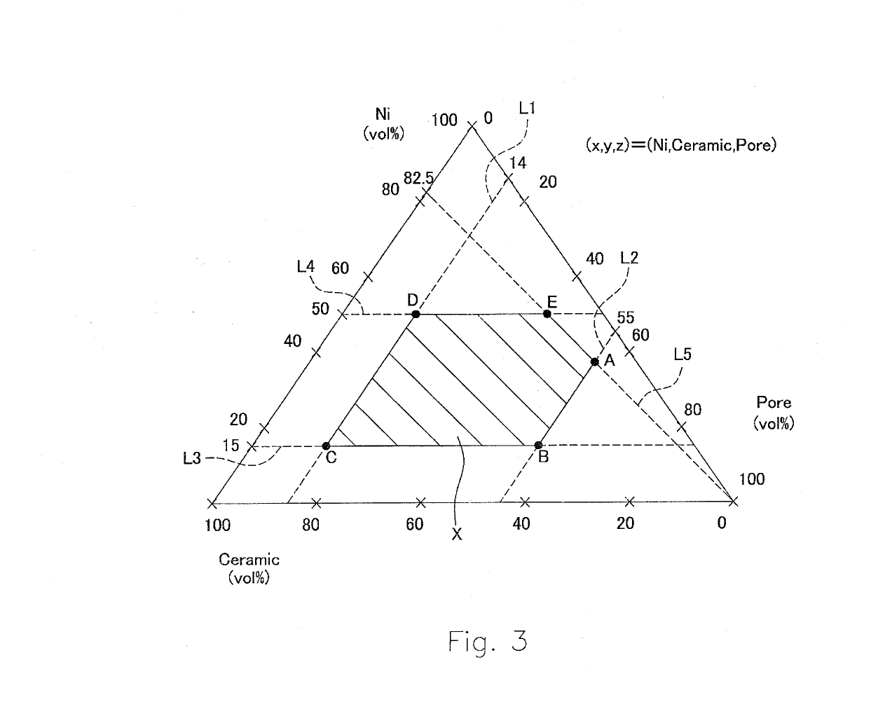

Next, the microstructure of the support substrate 10 as the porous body will be described making reference to the figures. FIG. 2 is a schematic view of a cross sectional surface of the interface between a support substrate 10 and the interconnector 20. FIG. 3 is a three-component composition diagram illustrating the volume ratio of pores, ceramic particles and Ni particles in the contacting region 101 of the support substrate 10. However, the volume ratio of the respective components in FIG. 3 is illustrated relative to the total volume of the Ni particles, the ceramic particles and the pores (hereinafter abbreviated to “total volume”). In the present embodiment, a reference to the volume ratio of the respective components will be taken to mean when the base support plate 10 is exposed to a reducing atmosphere.

As illustrated in FIG. 2, the support substrate 10 includes a contacting region 101 contacted with the interconnector 20. The contacting region 101 includes Ni particles, ceramic particles, and pores. At the interface P, the respective Ni particles, ceramic particles, and pores are contacted with the interconnector 20. The interface P can be defined as the line of the interconnector 20 closest to the support substrate 10. The interface P can be distinguished by observation using a scanning electron microscope (SEM).

The interface P may be discriminated as the boundary that is detected as the principal component included in the interconnector 20, for example, by using a wavelength dispersive X-ray spectrometry apparatus (WDS), or an energy dispersive X-ray spectrometry apparatus (EDS), or the like. Although the contacting region 101 is defined as the region within a predetermined distance (for example, no more than 5 microns) from the interface P, a least square line that passes through the interface P may be used in substitution for the interface P.

As illustrated in FIG. 3, when the support substrate 10 is exposed to a reducing atmosphere, if the points at which the Ni particles exhibit x volume %, the ceramic particles exhibit y volume %, the pores exhibit z volume % are taken to be (x,y,z), the respective volume ratios of the Ni particles, the ceramic particles and the pores to the total volume are positioned in a region X defined by a pentagon having apexes of point A (37.1, 7.9, 55.0), point B (15.0, 30.0, 55.0), point C (15.0, 71.0, 14.0), point D (50.0, 36.0, 14.0), and point E (50.0, 10.6, 39.4).

The region X is defined as the region enclosed by the first to fifth lines L1 to L5. The first line L1 is the line on which the volume ratio of the pores to the total volume is 14 volume %. The second line L2 is the line on which the volume ratio of the pores to the total volume is 55 volume %. The third line L3 is the line on which the volume ratio of the Ni particles to the total volume is 15 volume %. The fourth line L4 is the line on which the volume ratio of the Ni particles to the total volume is 50 volume %. The fifth line L5 is the line on which the volume ratio of the Ni particles to the sum volume of the volume of the ceramic particles and the volume of the Ni particles is 82.5 volume %.

Therefore, when the support substrate 10 is exposed to a reducing atmosphere, the region X is defined as the region that satisfies the following three conditions.

Condition (1): The volume ratio of the pores to the total volume is greater than or equal to 14 volume % and less than or equal to 55 volume %.

Condition (2): The volume ratio of the Ni particles to the total volume is greater than or equal to 15 volume % and less than or equal to 50 volume %.

Condition (3): The volume ratio of the Ni particles to the sum volume of the volume of the ceramic particles and the volume of the Ni particles is less than or equal to 82.5 volume %.

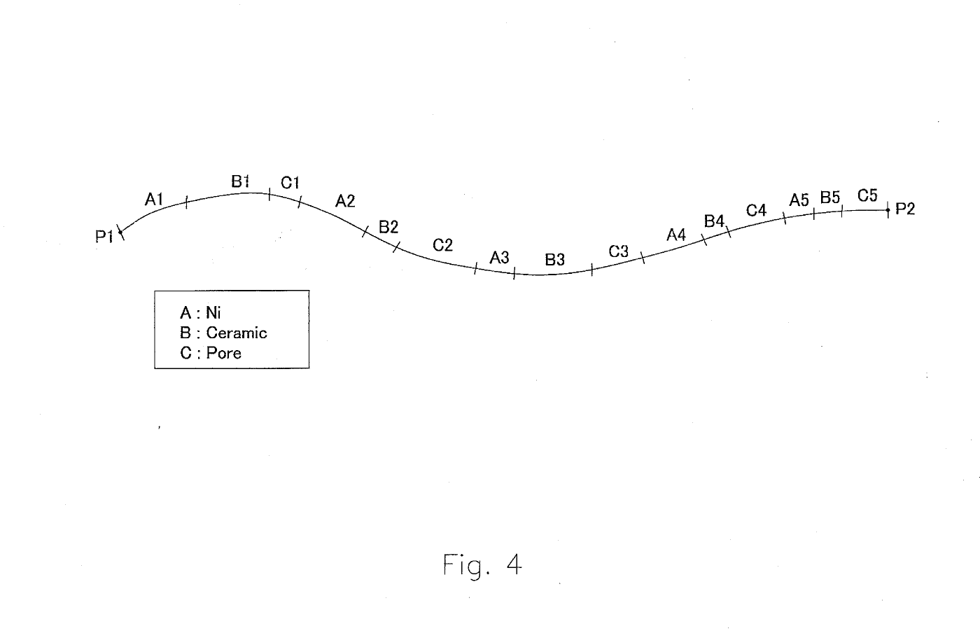

In this regard, the method of calculation of the volume ratio of the respective components to the total volume will be described. FIG. 4 illustrates a calculation method for the volume ratio, and is a schematic view that expands a portion of the interface P (P1 to P2). The interval P1 and P2 is for example of the order of 30 microns to 300 microns.

In FIGS. 4, A1 to A5 illustrates the contacting range of the Ni particles to the interconnector 20, B1 to B5 illustrates the contacting range of the ceramic particles to the interconnector 20, and C1 to C5 illustrates the contacting range of the pores to the interconnector 20. In this configuration, the volume ratio of the respective components to the total volume is estimated using Formulae (1) to (3) below, wherein W denotes the sum of A1-A5, B1-B5, and C1-C5 in Formulae (1) to (3).

Ni particles (volume %)=(A1+A2+A3+A4+A5)×100/W (1)

Ceramic particles (volume %)=(B1+B2+B3+B4+B5)×100/W (2)

Pores (volume %)=(C1+C2+C3+C4+C5)×100/W (3)

The volume ratio of Ni particles to the sum volume of the volume of the ceramic particles and the volume of the Ni particles is calculated by dividing the value of Formula (1) by the sum of the value of Formula (1) and the value of Formula (2).

The method of estimating a three dimensional structure from a two dimensional composition is disclosed in “Ceramic Processing”, Nobuyasu Mizutani, Yoshiharu Ozaki, Toshio Kimura, and Takashi Yamaguchi, Gihodo Shuppan Co., Ltd, Mar. 25, 1985, page 190 to page 201.

The average value of the contacting length of the Ni particles to the interconnector 20 (in FIG. 4, (A1+A2+A3+A4+A5)/5) is preferably greater than or equal to 0.51 microns and less than or equal to 3.1 microns. In the same manner, the average value of the contacting length of the ceramic particles to the interconnector 20 (in FIG. 4, (B1+B2+B3+B4+B5)/5) is preferably greater than or equal to 0.49 microns and less than or equal to 3.2 microns.

When the average value of the contacting length respectively of the Ni particles and the ceramic particles is calculated, it is preferred to omit extremely small values for the contacting length. There is due to the fact that there is a possibility that no enhancement of the tensile strength will be exhibited at contacting positions at which the contacting length is extremely small. More specifically, the average value of the contacting length respectively of the Ni particles and the ceramic particles is preferably calculated by omitting contacting positions at which the contacting length is less than 0.08 microns.

Method of Manufacturing Fuel Cell 100

The method of manufacturing the fuel cell 100 will be described below.

Firstly, an NiO powder and Y₂O₂ powder are mixed, and then a pore-forming agent (for example, cellulose, or PMMA particles having an average particle diameter of 0.5 microns to 20 microns), an organic binder, and water are mixed into the powder mixture to thereby form a raw material for the support substrate.

The raw material for the support substrate is extrusion molded, dried and calcined to thereby prepare a support substrate calcined body.

Next, a slurry obtained by mixing an organic binder and a powder of ZrO₂ (for example, 8YSZ, or the like) which includes addition of Y₂O₃ is subjected to a doctor blade method to thereby prepare a green sheet for the solid electrolyte layer.

Then, a paste is prepared by mixing an organic binder and a solvent with a powder of ZrO₂ (for example, 8YSZ) including a solid solution of Y₂O₃, and is coated and dried using a screen printing method onto a portion of the green sheet for the solid electrolyte layer to thereby form a coating layer for the anode layer.

Next, a stacked body is prepared by adhering the green sheet for the solid electrolyte layer with the coating layer for the anode layer onto the support substrate calcined body.

Then, the stacked body is calcined at a predetermined temperature (for example of approximately, 1000 degrees C.).

A paste formed by mixing an LaCrO₃-based oxide and an organic binder in a solvent is coated by printing onto an exposed portion of the support substrate green body, and fired at a predetermined temperature (1450 degrees C.).

Next, a slurry obtained by adding LSCF powder and a binder is printed and dried on the solid electrolyte layer, and then baked at a predetermined temperature (for example, 1150 degrees C.).

### Operation and Effect

When the support substrate 10 is exposed to a reducing atmosphere, the contacting region 101 of the support substrate 10 (that is an example of a porous body) according to the present embodiment exhibits a volume ratio of pores to the total volume that includes the Ni particles, the ceramic particles and the pores of at least 14 volume % to no more than 55 volume %.

In this manner, the Young's modulus in proximity to the interface P of the support substrate 10 can be reduced by a configuration in which the volume ratio of the pores is greater than or equal to 14 volume %. As a result, the stress produced in proximity to the interface P in response to expansion of the interconnector 20 during reducing operations can be reduced. A sufficient contacting width can be maintained between the Ni particles and the ceramic particles and the interconnector 20 since the volume ratio of the pores is less than or equal to 55 volume %. Therefore, since both mitigation of stress and maintenance of the contacting strength can be maintained, it is possible to suppress delamination between the support substrate 10 and the interconnector 20.

When the support substrate 10 is exposed to a reducing atmosphere, the volume ratio of Ni particles to the total volume that includes the Ni particles, the ceramic particles and the pores is greater than or equal to 15 volume % and less than or equal to 50 volume % in the contacting region 101.

In this manner, an increase in the electrical resistance at the contacting interface can be suppressed by ensuring numerous contacting positions between Ni particles by reason of a volume ratio of Ni particles of at least 15 volume %. Furthermore, the tendency of the electrical path to disconnect due to aggregation of Ni particles in a power generation atmosphere can be suppressed. In addition, excessive aggregation of Ni particles during reduction treatment can be suppressed by a configuration in which the volume ratio of Ni particles is less than or equal to 50 volume %.

When the support substrate 10 is exposed to a reducing atmosphere, the volume ratio of Ni particles to the sum volume of the volume of the Ni particles and the volume of the ceramic particles is less than or equal to 82.5 volume % in the contacting region 101.

### Other Embodiments

However, the present invention is not limited to an embodiment as described above, and various modifications and changes are possible within a scope that does not depart from the scope of the invention.

(A) Although the present embodiment has described a support substrate 10 as an example of a porous body that is contacted with an interconnector 20, there is no limitation in this regard. The interconnector 20 may be contacted with an intermediate layer that is inserted between the support substrate 10 and the interconnector 20. In this configuration, the intermediate layer and/or the support substrate 10 may be configured as a porous body. The conductivity of the intermediate layer is preferably higher than the conductivity of the support substrate 10 that functions as the anode current collecting layer.

(B) Although there is no particular disclosure in the present embodiment, the shape of the cell 100 may be applied to various configurations such as anode-supporting, flat, cylindrical, horizontally-striped configurations or the like. Furthermore, the cross sectional surface of the cell 100 may be oval or the like.

A segmented-in-series fuel cell includes provision of an insulated support substrate, a first and second power-generating section disposed on the support substrate, and a dense interconnector that is electrically connected to the first and the second power-generating sections. The insulated support substrate exhibits a porous configuration, includes an internal flow channel for the passage of fuel gas, and is formed as a flat plate. The power-generating section includes a conductive anode current collection layer, an anode active layer, a solid electrolyte layer, and a cathode. The anode current collection layer is formed on the support substrate. The anode active layer is formed on the anode current collection layer. The solid electrolyte layer is disposed between the anode active layer and the cathode. The interconnector is electrically connected to the anode current collection layer of the first power-generating section and the cathode of the second power-generating section. A portion of the interconnector is contacted with the surface of the anode current collection layer and surface of the support substrate.

The anode current collection layer in this type of segmented-in-series fuel cell may be an example of the “porous body”. That is to say, delamination between the anode current collection layer, that is the porous body, and the interconnector can be suppressed by a configuration in which the volume ratio of the pores to the total volume of the Ni particles, the ceramic particles and the pores in the anode current collection layer that includes the Ni particles, the ceramic particles and the pores is greater than or equal to 14 volume % and less than or equal to 55 volume %, the volume ratio of the Ni particles to the total volume is greater than or equal to 15 volume % and less than or equal to 50 volume %, and the volume ratio of the Ni particles to the sum volume of the volume of the ceramic particles and the volume of the Ni particles is less than or equal to 82.5 volume %. In this configuration, Ni may be included or Ni may not be included in the support substrate that supports the power-generating section.

Furthermore, the support substrate in this type of segmented-in-series fuel cell may be an example of the “porous body”. That is to say, delamination between the support substrate, that is the porous body, and the interconnector can be suppressed by a configuration in which the volume ratio of the pores to the total volume of the Ni particles, the ceramic particles and the pores in the support substrate that includes the Ni particles, the ceramic particles and the pores is greater than or equal to 14 volume % and less than or equal to 55 volume %, the volume ratio of the Ni particles to the total volume is greater than or equal to 15 volume % and less than or equal to 50 volume %, and the volume ratio of the Ni particles to the sum volume of the volume of the ceramic particles and the volume of the Ni particles is less than or equal to 82.5 volume %. In this configuration, Ni may be included or Ni may not be included in the support substrate that supports the power-generating section.

(C) In the present embodiment, although the support substrate 10 has a configuration that includes first and second curved side surfaces 10C, 10D, the shape of the side surface of the support substrate 10 is not limited thereby.

(D) In the present embodiment, although the first seal portion 32a and the second seal portion 32b are configured to cover the first curved side surface 10C and the second curved side surface 10D of the support substrate 10, the side of the “anode” may be covered.

(E) In the present embodiment, although the first seal portion 32a and the second seal portion 32b are configured by a solid electrolyte layer 32 that extends on the support substrate 10, the solid electrolyte layer 32 may be formed as another member.

### EXAMPLES

Although the examples of a cell according to the present invention will be described below, the present invention is not limited to the following examples.

Manufacture of Samples No. 1 to No. 22

In the following description, Samples No. 1 to No. 22 are prepared to have a configuration including an NiO—Y₂O₃ plate (support substrate) and interconnector.

Firstly, PMMA as a pore forming agent was added to a powder formed by mixing NiO powder and Y₂O₃ powder. In the Samples No. 1 to No. 22, the powder was mixed in a range of NiO powder (20 wt % to 90 wt %) and Y₂O₃ powder (10 wt % to 80 wt %). Thereafter, the pore forming agent was added in a range of 0 wt % to 30 wt % to the total weight of NiO and Y₂O₃.

Next, the powder including the pore forming agent was introduced into a mill containing pebbles, and was mixed for three hours with water and a dispersant to thereby prepare a slurry.

Then, after filtering of the slurry in a sieve having openings of 150 microns, polyvinyl alcohol (PVA) was added as a binder, and drying at 100 degrees C. was performed in a drying apparatus. Thereafter, the dried powder was passed again through a sieve having openings of 150 microns to thereby prepare a granulated powder.

Then, NiO—Y₂O₃ pellets having a diameter of 30 mm and a thickness of 2.0 mm were prepared by uniaxial pressing of the granulated powder at surface pressure of 0.4 t/cm².

Next, the paste for screen printing was prepared by using a tri-roll mill to mix lanthanum chromite doped with calcium, polyvinyl butyral (PVB) as a binder, and terpineol as a solvent.

Next, the paste was screen printed onto the pellets to have a thickness after firing of 40 microns, and was fired for 5 hours at 1450 degrees C. In this manner, Samples No. 1 to No. 22 were prepared as a cofired body.

Conductivity Inspection after Reduction Treatment of Samples No. 1 to No. 22

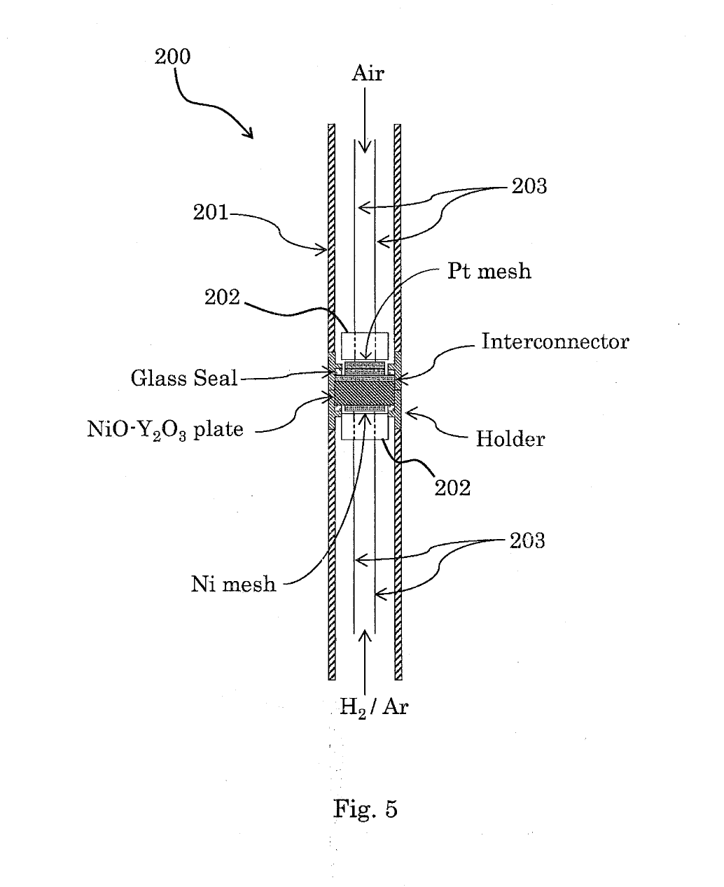

Samples No. 1 to No. 22 were placed in a voltage evaluation apparatus 200 as illustrated in FIG. 5 and the presence or absence of conductivity was confirmed after reduction treatment of the NiO. The voltage evaluation apparatus 200 included a capsule 201 that was divided into an upper portion and a lower portion. Pt pedestals 202 were respectively disposed in the upper portion and the lower portion of the capsule 201, and each of the Pt pedestals 202 was connected to two Pt lines 203 (potential line and current line).

The arrangement of Samples No. 1 to No. 22 was configured so that the interconnector is connected to the Pt pedestal 202 in the upper portion of the capsule 201, and the NiO—Y₂O₃ plate was connected to the Pt pedestal 202 in the lower portion of the capsule 201. The interval between the test piece and the capsule was sealed with molten glass so that gas does not mix between the upper portion and the lower portion of the capsule, and 35% H₂/Ar gas flow was applied to the lower portion of the capsule and a flow of air was applied to the upper portion of the capsule.

After the NiO was sufficiently reduced, the presence or absence of conductivity was confirmed by measurement of the potential during flow of a constant current 1A on the Pt pedestal. The results are shown in Table 1.

Three-Component Composition Diagram of Samples No. 1 to No. 22

As described below, the cutting plane observation of Samples No. 1 to No. 22 was performed to thereby analyze the microstructure of the NiO—Y₂O₃ plate in proximity to the interface of the NiO—Y₂O₃ plate and the interconnector.

Firstly, a resin was impregnated into the pores of the NiO—Y₂O₃ plate by drawing to create a vacuum while dripping an epoxy resin onto Samples No. 1 to No. 22 after reduction treatment. After curing the resin overnight, a cutting plane of the NiO—Y₂O₃ plate/interconnector was obtained by cutting each sample along the direction of thickness by use of a microcutter.

After the cutting plane was flatted with #600 water resistant paper, the cutting plane was smoothed with an ion milling apparatus (a cross section polisher manufactured by JEOL Ltd.).

Next, the cutting plane of each sample was observed using a high resolution FE-SEM that enables non-deposition observation at a low acceleration. When capturing an in-lens and out-lens image, three phases having different contrasts were observed. The three phases are the Ni particles, the ceramic particles and the pores. The length of contact of the three phases with the interconnector was measured to thereby calculate the respective ratios and estimate the volume ratio of the Ni particles, the ceramic particles and the pores in the contacting region.

Next, spot analysis using an energy dispersive X-ray spectrometry (EDS) apparatus was employed to clarify which of the regions that include the respective contrasts correspond to each of the Ni particles, the ceramic particles and the resin (that is to say, the pores). The closed pores that were not impregnated with resin were discriminated by visual inspection of a region(s) that is depressed from the smooth surface.

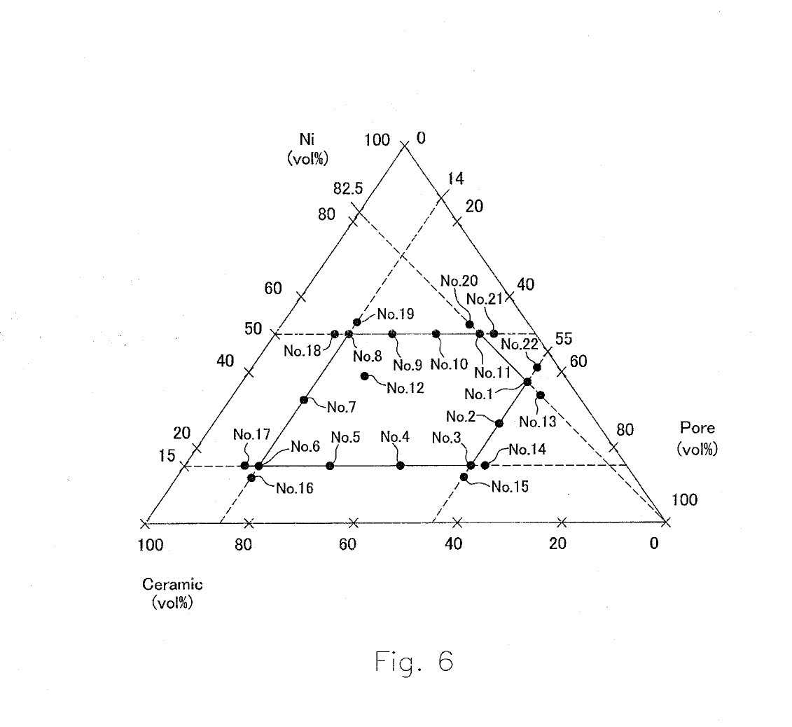

As illustrated in FIG. 6, a three-component composition diagram showing the volume ratio of the Ni particles, the ceramic particles and the pores in the respective contacting regions of Samples No. 1 to No. 22 was acquired.

Delamination Inspection after Reduction Treatment of Samples No. 1 to No. 22

As described below, the presence or absence of delamination at the interface between the interconnector and the NiO—Y₂O₃ plate was confirmed in relation to Samples No. 1 to No. 22. In the present embodiment, after a 10-hour exposure of Samples No. 1 to No. 22 to hydrogen at 800 degrees C., and after a 500-hour exposure, three positions on the cutting plane of each sample were observed at a 2000 magnification. The results for the presence or absence of delamination are shown in Table 1.

TABLE 1

| | | | | | | Delamination | | |
|---|---|---|---|---|---|---|---|---|
| Sample | Ni | Y₂O₃ | Pores | Delamination | Delamination | after 500 hr + | | |
| No. | (Vol %) | (Vol %) | (Vol %) | After 10 hr | After 500 hr | 10 heat cycles | Conductivity | Evaluation |
| 1 | 37.1 | 7.9 | 55.0 | Not Delaminated | Not Delaminated | Not Delaminated | Conducted | ◯ |
| 2 | 27.0 | 18.0 | 55.0 | Not Delaminated | Not Delaminated | Not Delaminated | Conducted | ◯ |
| 3 | 15.0 | 30.0 | 55.0 | Not Delaminated | Not Delaminated | Not Delaminated | Conducted | ◯ |
| 4 | 15.0 | 42.0 | 43.0 | Not Delaminated | Not Delaminated | Not Delaminated | Conducted | ◯ |
| 5 | 15.0 | 57.0 | 28.0 | Not Delaminated | Not Delaminated | Not Delaminated | Conducted | ◯ |
| 6 | 15.0 | 71.0 | 14.0 | Not Delaminated | Not Delaminated | Not Delaminated | Conducted | ◯ |
| 7 | 33.0 | 53.0 | 14.0 | Not Delaminated | Not Delaminated | Not Delaminated | Conducted | ◯ |
| 8 | 50.0 | 36.0 | 14.0 | Not Delaminated | Not Delaminated | Not Delaminated | Conducted | ◯ |
| 9 | 50.0 | 28.0 | 22.0 | Not Delaminated | Not Delaminated | Not Delaminated | Conducted | ◯ |
| 10 | 50.0 | 18.0 | 32.0 | Not Delaminated | Not Delaminated | Not Delaminated | Conducted | ◯ |
| 11 | 50.0 | 10.6 | 39.4 | Not Delaminated | Not Delaminated | Not Delaminated | Conducted | ◯ |
| 12 | 38.0 | 38.0 | 24.0 | Not Delaminated | Not Delaminated | Not Delaminated | Conducted | ◯ |
| 13 | 35.5 | 7.5 | 57.0 | Not Delaminated | Not Delaminated | Delaminated | Not Conducted | X |
| 14 | 15.0 | 28.0 | 57.0 | Not Delaminated | Not Delaminated | Delaminated | Not Conducted | X |
| 15 | 13.0 | 32.0 | 55.0 | Not Delaminated | Delaminated | — | Not Conducted | X |
| 16 | 13.0 | 73.0 | 14.0 | Not Delaminated | Delaminated | — | Not Conducted | X |
| 17 | 15.0 | 73.0 | 12.0 | Delaminated | — | — | Not Conducted | X |
| 18 | 50.0 | 38.0 | 12.0 | Delaminated | — | — | Not Conducted | X |
| 19 | 52.0 | 34.0 | 14.0 | Not Delaminated | Delaminated | — | Not Conducted | X |
| 20 | 52.0 | 11.0 | 37.0 | Not Delaminated | Delaminated | — | Not Conducted | X |
| 21 | 50.0 | 8.6 | 41.4 | Not Delaminated | Delaminated | — | Not Conducted | X |
| 22 | 39.1 | 5.9 | 55.0 | Not Delaminated | Delaminated | — | Not Conducted | X |

As clearly shown by Table 1 and FIG. 6, good results are obtained in relation to conductivity inspection and delamination inspection in Samples No. 1 to No. 12. In the three-component composition diagram illustrated in FIG. 6, the volume ratio of Samples No. 1 to No. 12 form a pentagonal region that has apexes such that (N₁, Y₂O₃, pores)=(37.1, 7.9, 55.0), (15.0, 30.0, 55.0), (15.0, 71.0, 14.0), (50.0, 36.0, 14.0), and (50.0, 10.6, 39.4). Samples No. 13 to No. 22 that are outside the pentagon do not obtain good results in relation to conductivity inspection and delamination inspection. Therefore, it can be shown that adjustment to a volume ratio within the pentagonal region illustrated in FIG. 6 is preferred.

Preparation of Samples No. 23 to No. 39

Samples No. 23 to No. 39 were prepared in the same manner as the preparation method of Samples No. 1 to No. 22 as described above. However in Samples No. 23 to No. 39, the contacting length of each of the Ni particles and the Y₂O₃ particles with the interface as illustrated in FIG. 2 was adjusted by causing the raw material particle diameter of the Ni powder and the Y₂O₃ powder that configures the NiO—Y₂O₃ plate to diverge respectively into a range of 0.2 microns to 10 microns.

The average value of the contacting length of each of the Ni particles and the Y₂O₃ particles with the interface was calculated by observation of the cutting plane of Samples No. 23 to No. 39 using the same method as that described above. The calculation results are shown in Table 2.

Sebastian Testing of Samples No. 23 to No. 39

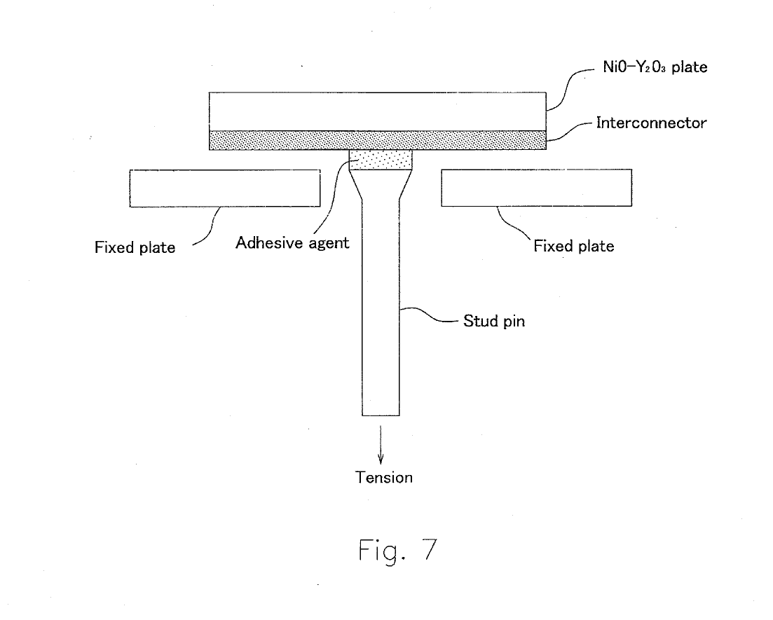

The contacting strength in Samples No. 23 to No. 39 between the NiO—Y₂O₃ plate and the interconnector was measured by delamination the NiO—Y₂O₃ plate from the interconnector using the apparatus illustrated in FIG. 7.

Firstly, after exposure of Samples No. 23 to No. 39 for 10 hours in hydrogen at 800 degrees C., the temperature is reduced while maintaining the reducing atmosphere to thereby avoid re-oxidization.

Next, as illustrated in FIG. 7, the tensile strength when delamination the NiO—Y₂O₃ plate from the interconnector and when pulling the stud pin attached to the interconnector by an adhesive was measured. The details of Sebastian testing were performed in accordance with the description in “Oyama Takeshi, “Adherence test using vertical pull instrument with stud pin” The Surface Finishing, vol. 58, page 292 (2007)”.

The measurement results are shown in Table 2. Table 2 states the strength ratio as standardized with reference to the strength of Sample No. 31 that has the highest strength. In the present embodiment, the strength ratio is determined to be good when at least 0.9.

TABLE 2

| | | | | Average | Average | |
|---|---|---|---|---|---|---|
| | | | | Length | Length | |
| | | | | of Ni | of Y₂O₃ | |
| Sample | Ni | Y₂O₃ | Pores | Particles | Particles | Strength |
| No. | (Vol %) | (Vol %) | (Vol %) | (microns) | (microns) | Ratio |
| 23 | 38.3 | 38.1 | 23.6 | 0.31 | 0.20 | 0.65 |
| 24 | 38.1 | 37.9 | 24.0 | 0.15 | 0.21 | 0.62 |
| 25 | 38.2 | 37.9 | 23.9 | 5.1 | 0.22 | 0.59 |
| 26 | 37.9 | 38.1 | 24.0 | 0.51 | 0.50 | 0.93 |
| 27 | 37.8 | 38.2 | 24.0 | 1.5 | 0.51 | 0.97 |
| 28 | 37.9 | 38.0 | 24.1 | 3.1 | 0.49 | 0.95 |
| 29 | 37.9 | 38.1 | 24.0 | 0.31 | 1.5 | 0.62 |
| 30 | 38.0 | 38.0 | 24.0 | 0.52 | 1.4 | 0.96 |
| 31 | 38.1 | 38.0 | 23.9 | 1.6 | 1.5 | 1 |
| 32 | 38.0 | 38.3 | 23.7 | 3.1 | 1.6 | 0.97 |
| 33 | 38.3 | 38.2 | 23.5 | 5.1 | 1.5 | 0.59 |
| 34 | 37.9 | 37.8 | 24.3 | 0.51 | 3.1 | 0.98 |
| 35 | 37.9 | 38.0 | 24.1 | 1.6 | 3.0 | 0.97 |
| 36 | 37.8 | 37.9 | 24.3 | 3.1 | 3.2 | 0.96 |
| 37 | 38.1 | 38.2 | 23.7 | 0.31 | 5.1 | 0.62 |
| 38 | 38.2 | 38.1 | 23.7 | 1.5 | 4.9 | 0.68 |
| 39 | 38.3 | 38.2 | 23.5 | 5.1 | 5.2 | 0.7 |

As illustrated in Table 2, the average contacting length of the Ni particles is shown to be preferably greater than or equal to 0.51 microns and less than or equal to 3.1 microns. Furthermore, the average contacting length of Y₂O₃ is shown to be preferably greater than or equal to 0.49 microns and less than or equal to 3.2 microns. The respective average contacting lengths of the Ni particles and Y₂O₃ is calculated by eliminating contacting positions at which the contacting length is less than 0.08 microns.

1. A fuel cell comprising:
a porous body including Ni particles, ceramic particles and pores;
an anode active layer formed on the porous body;
a cathode;
a solid electrolyte layer disposed between the anode active layer and the cathode;
a dense interconnector formed on the porous body, and electrically connected with the anode active layer;
the porous body and the interconnector cofired, the porous body including a contacting region within a predetermined distance from a interface with the interconnector, the contacting region connected to the interconnector,
when the porous body is exposed to a reducing atmosphere, a volume ratio of the pores to a total volume of the Ni particles, the ceramic particles and the pores being greater than or equal to 14 volume % and less than or equal to 55 volume % in the contacting region, a volume ratio of the Ni particles to the total volume being greater than or equal to 15 volume % and less than or equal to 50 volume % in the contacting region, and a volume ratio of the Ni particles to a sum volume of a volume of the ceramic particles and a volume of the Ni particles being less than or equal to 82.5 volume % in the contacting region, and
the volume ratio of the pores to the total volume, the volume ratio of the Ni particles to the total volume and the volume ratio of the Ni particles to the sum volume being calculated based on contacting length of each of the Ni particles, the ceramic particles and the pores with the interconnector in the interface between the porous body and the interconnector.

2. The fuel cell according to claim 1, wherein
when the porous body is exposed to a reducing atmosphere, an average contacting length of the Ni particles with the interconnector is greater than or equal to 0.51 microns and less than or equal to 3.1 microns.

3. The fuel cell according to claim 1, wherein
when the porous body is exposed to a reducing atmosphere, an average contacting length of the ceramic particles with the interconnector is greater than or equal to 0.49 microns and less than or equal to 3.2 microns.

4. The fuel cell according to claim 1, wherein
the interconnector is configured by a lanthanum-chromite-based perovskite oxide.

5. The fuel cell according to claim 1 further comprising:
a flat support substrate including an internal flow channel for passing of fuel gas.

6. A fuel cell comprising:
a porous body including Ni particles, ceramic particles and pores;
an anode active layer formed on the porous body;
a cathode;
a solid electrolyte layer disposed between the anode active layer and the cathode;
a dense interconnector formed on the porous body, and electrically connected with the anode active layer; wherein:
the porous body and the interconnector cofired,
the porous body including a contacting region within a predetermined distance from a interface with the interconnector, the contacting region connected to the interconnector,
when the porous body is exposed to a reducing atmosphere, the respective volume ratios of the Ni particles, the ceramic particles and the pores to a total volume of the Ni particles, the ceramic particles and the pores in the contacting region being positioned in a region defined by a pentagon having apexes at (37.1, 7.9, 55.0), (15.0, 30.0, 55.0), (15.0, 71.0, 14.0), (50.0, 36.0, 14.0), and (50.0, 10.6, 39.4) in a three-component composition diagram, a point at which the Ni particles exhibit x volume %, the ceramic particles exhibit y volume %, the pores exhibit z volume % being expressed as (x,y,z), and
the respective volume ratios of the Ni particles, the ceramic particles and the pores to the total volume being calculated based on contacting length of each of the Ni particles, the ceramic particles and the pores with the interconnector in the interface between the porous body and the interconnector.
